(19) United States
(12) Patent Application Publication
(10) Pub. No.: US 2005/0257806 A1
(43) Pub. Date: Nov. 24, 2005

(54) Floss out

(76) Inventors: Robert J. Hay, Benicia, CA (US); Jacqueline M. Hay, Benicia, CA (US); Heather Hay, Benicia, CA (US)

Correspondence Address: ROBERT J. HAY, 115 WOODSTOCK CT., BENICIA, CA, 94510, US

(21) Appl. No.: 10/770,910

(22) Filed: May 19, 2004

(51) Int. Cl. A61C 15/00

(52) U.S. Cl. 132/321

(57) ABSTRACT

The FLOSS OUT is a flexible floss string with a distinct color seperation commencing at least two (2) feet, twenty-four (24) inches, from the end, creating one (1) continuous flexible floss string which contains two (2) colors, which will warn and alert the user that the flexible floss string is about to come to an end.

### BACKGROUND OF THE INVENTION

This invention relates to an improved floss design. By way of background, the present floss available fails to warn the user that they are coming to the end of their floss. It is with overcoming the deficiency of the foregoing type of floss that the present invention is concerned.

### SUMMARY OF THE INVENTION

It is accordingly one object of the present invention to provide an improved floss design with a distinct color seperation at least two (2) feet, twenty-four (24) inches, from the end of the floss.

Another object of the present invention is to provide an improved floss with a distinct color change near the end of the floss that will warn, or alert, the user that he/she is about to come to the end of their floss.

Another object of the present invention will be to inform the user that it is time to purchase more “FLOSS OUT”.

### BRIEF DESCRIPTION OF THE DRAWING

In order that the invention be more fully comprehended, it will now be described, by way of example, with reference to the accompanying drawings, in which:

FIG. 1 is a perspective view of the improved floss design, with its distinct color change. The new “FLOSS OUT” shows the last portion of the floss, the left side, as you are viewing it, from the left side, right side, top view, and bottom view.

FIG. 2 is a front view showing the “FLOSS OUT” exiting a dental floss container with the color change floss shown.

### DESCRIPTION OF THE PREFERRED EMBODIMENT

It is to be understood that the phraseology, or terminology, employed is for the purpose of description only and not of limitation.

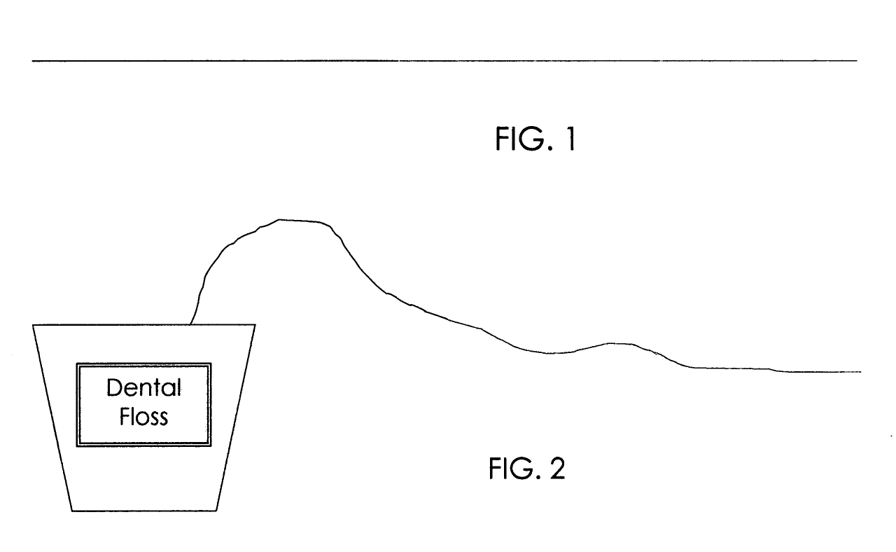

In FIG. 1, the new “FLOSS OUT” shows the last portion of the floss, the left side, as you are viewing it, to be a different color from the beginning of the floss. The last portion of the “FLOSS OUT” is the last part that exits the container holding the flexible “FLOSS OUT”.

In FIG. 2, the new “FLOSS OUT” is shown exiting a dental floss container with the color change in the floss visible.

1. We claim as our invention, the FLOSS OUT. This invention is a flexible floss string with a distinct color separation at least two (2) feet, twenty-four (24) inches, from the end of the floss.
